(19) United States
(12) Patent Application Publication
(10) Pub. No.: US 2004/0160649 A1
(43) Pub. Date: Aug. 19, 2004

(54) Device for scanning films

(76) Inventor: Wolfgang Steinebach, Salz (DE)

Correspondence Address: Joseph S Tripoli, Thomson Multimedia Lincensing Inc, Patent Operations CN 5312, Princeton, NJ, 08543-0028, US

(21) Appl. No.: 10/473,471

(22) PCT Filed: Mar. 22, 2002
(86) PCT No.: PCT/EP02/03254

(30) Foreign Application Priority Data
Mar. 28, 2001 (DE) 10115342.2

(51) Int. Cl. H04N 1/23; H04N 1/46

(52) U.S. Cl. 358/506; 348/96; 358/302; 358/479

(57) ABSTRACT

In a device for scanning films using at least one sensor with discrete light-sensitive elements, the light-sensitive elements of the sensor are randomly addressable for the read-out of video signals. Provision is made for an arrangement for addressing adapted to the imaging of the film on the sensor. In this case, the film may be imaged with the entire width on the sensor. Groups of pixels onto which in each case the filmed image, the perforation and, if appropriate, an optical sound track are imaged are addressed and read out separately.

The invention relates to a device for scanning films using at least one sensor with discrete light-sensitive elements.

Devices for scanning films, usually called film scanners, serve for generating video signals including the associated audio signals in the case of a sound film, in order to transmit the images and sounds stored on the film via a television or to store them on electromagnetic or electronic storage media. In recent decades, CCD sensors have proved to be successful as sensors for film scanners, but they encounter limits with regard to their resolution and speed. In order to realize an image resolution of approximately 4000×3000 pixels at 30 images per second, it would be necessary, by way of example, to generate and process six channels per color separation with 670 pixels per channel at a pixel rate of 60 MHz. Furthermore, CCD sensors are relatively inflexible, inter alia with regard to changes in the resolution. Before the beginning of a new line, it is generally always necessary for a complete line to be read out.

It is an object of the present invention to propose a device for scanning films which can be adapted in a simple manner to the geometrical conditions of the respective film to be scanned and, in the process, at least achieves the quality features existing with the known film scanners, such as resolution and signal-to-noise ratio, for example.

This object is achieved according to the invention by virtue of the fact that the light-sensitive elements of the sensor are randomly addressable for the read-out of video signals, and that provision is made for an arrangement for addressing adapted to the imaging of the film on the sensor.

The random access to the light-sensitive elements and thus to arbitrary pixels of the scanned film makes it possible to adapt the scanned image width dynamically to the requirements. In particular, this enables a development of the invention which consists in the fact that the film is imaged with the entire width on the sensor, and that groups of pixels onto which in each case the film image, the perforation and, if appropriate, an optical sound track are imaged are addressed and read out separately. As a result, one sensor can be used not only for the evaluation of the film images and the optical sound track which may be present but also for obtaining signals for improving image stability through the scanning of the perforation. The active image width of the film, that is to say the actual image region, can be read out in a freely selectable manner.

Therefore, at fixedly predetermined data rates, smaller image excerpts (fewer pixels) can be read out at a high line frequency and thus also at a high image repetition rate or larger image excerpts (more pixels) can be read out at a low line frequency and therefore at a correspondingly low image repetition rate. It thus becomes possible to adapt the region to be processed to the film format and to read out only the region of interest. Examples of such film formats are: Full Aperture 35 mm, Academy 35 mm, S 16 mm and 16 mm.

The scanning of the entire film width proposed in accordance with the development of the invention may be effected with 6000 pixels, for example. This has the advantage that the entire information of the film including the position of the perforation holes and the optical sound that is possibly present is present and can be enlisted as required for further signal processing. To that end, it is possible to design a sensor structure which makes a plurality of outputs available in parallel in order to feed them to different processing stages, for example video processing, audio processing or image stability correction.

An advantageous refinement of the invention consists in the fact that the sensor is a CMOS-Sensor. These sensors are particularly well suited to high resolutions and to integration of the circuits required for random addressing on the chip. CMOS-Sensors are described for example in Mansoorian B. et al. “250 mW, 60 Frames-per-Second, 1280Hx720V Pixel CMOS Digital Image Sensor (PB-0720)”. Paper at the International Solid-State Circuits Conference, Feb. 17, 1999, in EP 0 905 787 A2 and in WO98/56170.

In the device according to the invention, it may be provided that the sensor is a linear array sensor. To that end, it is possible to use the continuous film drives known for film scanners with CCD linear array sensors, considerable simplifications resulting from the common scanning of image, sound and perforation in accordance with the abovementioned development.

However, it is also possible within the scope of the invention to use an area array sensor as the sensor. Suitable drives with intermittent film transport are known for this.

In both cases it is possible within the scope of the invention to use one sensor for three-color separations or, in conjunction with a color splitter, three sensors for one respective color separation.

An advantageous refinement of the device according to the invention consists in the fact that, from the different groups of light-sensitive elements, the signals can be read into a video processing circuit, into an audio processing circuit and into a circuit for evaluating the perforation. In this case it is preferably provided that the video processing circuit, the audio processing circuit and the circuit for evaluating the perforation are arranged on a chip with the sensor. One or a plurality of Analog/Digital-converters may likewise be arranged on the chip. In addition to simplification and reduction of costs by virtue of a high degree of integration, the possible speed during signal processing is also increased as a result.

The random access to the individual pixels enables further improvements in the previous film scanners. Thus, by example, provision may be made for a device for correlated double scanning. The device for correlated double scanning is preferably arranged on the chip.

Exemplary embodiments of the invention are illustrated in the drawing on the basis of a number of figures and are explained in more detail in the description below. In the figures:

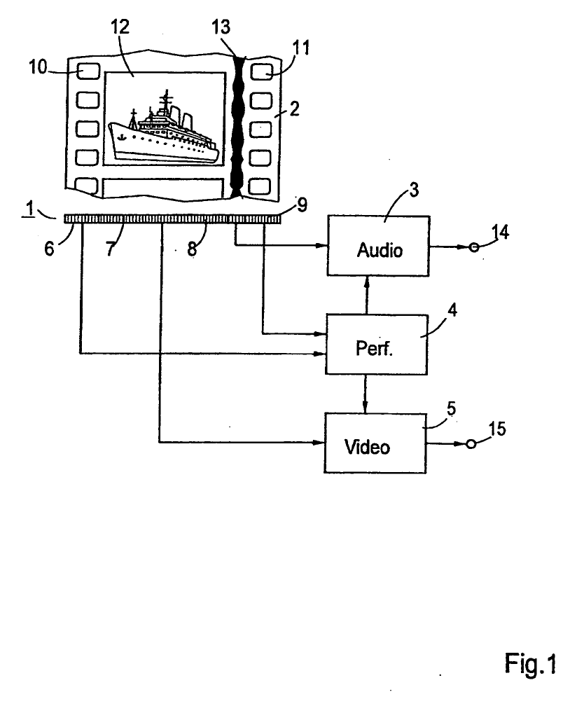

FIG. 1 shows a diagrammatic illustration of a device according to the invention,

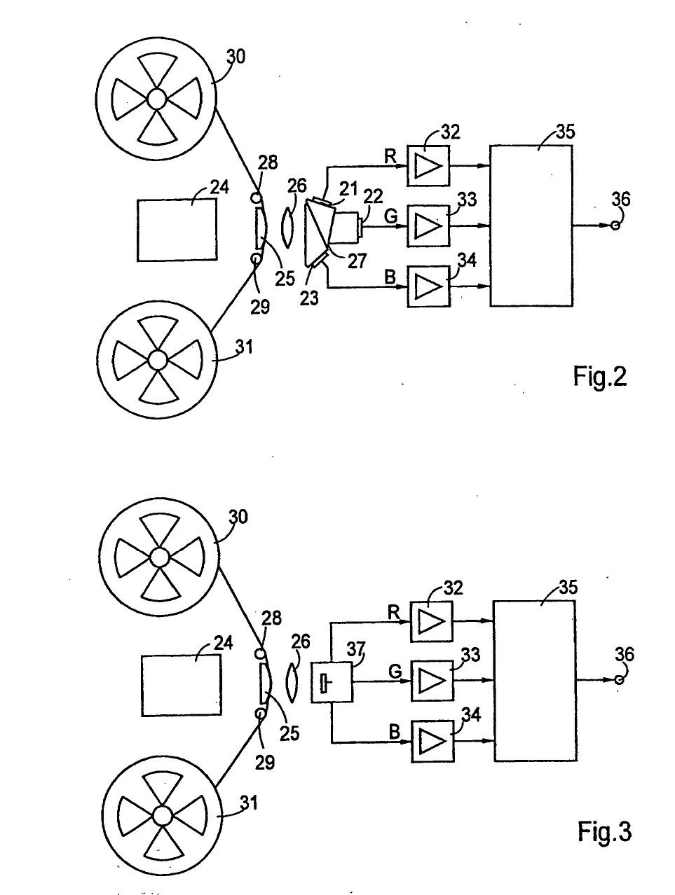

FIG. 2 shows the essential parts of a film scanner with three sensors, and

FIG. 3 shows the essential parts of a film scanner with a three-color sensor in each case in a greatly simplified illustration.

FIG. 1 merely shows the parts required for understanding the invention, namely a linear array sensor 1, a section of a film 2, an audio processing circuit 3, a circuit for evaluating the perforation 4 and a video processing circuit 5. The sensor 1 is provided with drive and read-out circuits internally, that is to say on a single chip, so that signals are read out from regions 6, 7, 8, 9 via a respective output. Overall, the linear array sensor 1 has about 6000 light-sensitive elements, which are merely indicated by vertical hatching.

The perforation 10, 11 of the film 2 is imaged onto the regions 6 and 9. The film images 12 are imaged onto the region 7, while the region 8 serves for scanning the sound track 13.

The evaluation of the signals obtained from the scanning of the perforation 10, 11 in the circuit 4 is effected in such a way that signals are derived which correspond to the differences between the actual film running and the ideal film running in the horizontal and vertical directions and are fed to the audio processing circuit 3 and the video processing circuit 5 for signal correction.

With the aid of the region 8, signals are generated in which the number of “black” pixels corresponds to the width of the sound track 13. These signals are subjected to corresponding recoding to generate a digital audio signal which can be taken from an output 14—if appropriate after a delay correction with the aid of the signals obtained from the perforation. The video signals corrected in a similar manner can be taken from an output 15.

FIG. 2 shows a film scanner with three sensors 21, 22, 23. The film guided past a film window 25 is exposed by an illumination device 24. In this case, the film is transported from a supply reel 30 via a first roller 28, the film window 25 and a second roller 29 to a take-up reel 31.

The respective line of the film is imaged onto the sensors 21, 22, 23 with the aid of an objective 26, a color splitter 27 allocating to the sensors in each case the color components with are fed as corresponding signals R, G, B via amplifiers 32, 33, 34 to a video processing circuit 35, at the output 36 of which the entire color video information can be taken in a suitable format.

In contrast to the film scanner according to FIG. 2, the film scanner according to FIG. 3 has a three-color sensor 37, which generates three color signals R, G, B. For the rest, the film scanner according to FIG. 3 is identical to that according to FIG. 2.

1. A device for scanning films using at least one sensor with discrete light-sensitive elements,
wherein
the light-sensitive elements of the sensor (1, 21, 22, 23, 37) are randomly addressable for the read-out of video signals, and wherein provision is made for an arrangement for addressing adapted to the imaging of the film (2) on the sensor (1, 21, 22, 23, 37).

2. The device as claimed in claim 1,
wherein
the film (2) is imaged with the entire width on the sensor (1, 21, 22, 23, 37), and
wherein groups of pixels onto which in each case the film image (12), the perforation (10, 11) and, if appropriate, an optical sound track (13) are imaged are addressed and read out separately.

3. The device as claimed in one of the preceding claims,
wherein
the sensor (1, 21, 22, 23, 37) is a CMOS sensor.

4. The device as claimed in one of the preceding claims,
wherein
the sensor (1, 21, 22, 23, 37) is a linear array sensor.

5. The device as claimed in one of claims 1 to 3,
wherein
the sensor is an area array sensor.

6. The device as claimed in claim 2,
wherein
from the different groups of light-sensitive elements, the signals can be read into a video processing circuit (5), into an audio processing circuit (3) and into a circuit (4) for evaluating the perforation.

7. The device as claimed in claim 6,
wherein
the video processing circuit (5), the audio processing circuit (3) and the circuit (4) for evaluating the perforation are arranged on a chip with the sensor.

8. The device as claimed in one of the preceding claims,
wherein
provision is furthermore made for a device for correlated double scanning.

9. The device as claimed in claim 8,
wherein
the device for correlated double scanning is arranged on the chip.
